(19) United States
(12) Patent Application Publication
(10) Pub. No.: US 2014/0122577 A1
(43) Pub. Date: May 1, 2014

(54) SYSTEM AND METHOD FOR EVALUATING READINESS OF APPLICATIONS FOR THE CLOUD

(71) Applicant: SYNTEL, INC., Troy, MI (US)

(72) Inventor: ASHOK BALASUBRAMANIAN, Irving, TX (US)

(21) Appl. No.: 14/063,516

(22) Filed: Oct. 25, 2013

Related U.S. Application Data
(60) Provisional application No. 61/718,779, filed on Oct. 26, 2012.

(51) Int. Cl. H04L 29/08

(52) U.S. Cl. CPC H04L 67/10
USPC 709/203

(57) ABSTRACT

A system and method of evaluating readiness of applications for the cloud. In one embodiment, the method the step of planning a scope of work by assessing which software applications are under consideration for migration to the cloud. The software applications under consideration are assessed for migration to the cloud to determine technical objectives The method includes the step of analyzing the software applications under consideration for migration to the cloud to determine a score representative to propensity of respective applications to a public, private or hybrid cloud architecture. A migration strategy is defined based on the accessing and analyzing steps. This allows a recommendation of readiness of the applications under consideration for migration to the cloud.

### RELATED APPLICATIONS

The present application is related to and claims priority to U.S. Provisional Patent Application Ser. No. 61/718,779, filed on Oct. 26, 2012, entitled “System and Method for Evaluating Readiness of Applications for the Cloud.” The subject matter disclosed in that provisional application is hereby expressly incorporated by reference into the present application in its entirety.

### TECHNICAL FIELD

The present disclosure relates generally to computerized systems and methods, and in particular, to a computerized system and method for evaluating readiness of applications for the cloud.

### BACKGROUND AND SUMMARY

In general, “cloud computing” refers to technologies that provide computation, software, data access, and/or storage services that do not require end-use-knowledge of the physical location and configuration of the system that delivers the services. Many organizations are transitioning locally installed or accessible software and/or platforms to the cloud, which provides a service delivery model that often brings cost benefits and flexibility.

For those organizations that would want to move from a conventional computing environment to a cloud computing environment, an evaluation process must be undertaken to identify the kind of cloud computing environment suitable to them and creation of a roadmap for moving to that target cloud environment. This involves creation of the most appropriate cloud platform and application architecture. It also involves prioritization of applications to be migrated to this cloud platform and architecture.

According to one aspect, the invention provides a method of evaluating readiness of applications for the cloud. In one embodiment, the method the step of planning a scope of work by assessing which software applications are under consideration for migration to the cloud. The software applications under consideration are assessed for migration to the cloud to determine technical objectives The method includes the step of analyzing the software applications under consideration for migration to the cloud to determine a score representative to propensity of respective applications to a public, private or hybrid cloud architecture. A migration strategy is defined based on the accessing and analyzing steps. This allows a recommendation of readiness of the applications under consideration for migration to the cloud.

Additional features and advantages of the invention will become apparent to those skilled in the art upon consideration of the following detailed description of the illustrated embodiment exemplifying the best mode of carrying out the invention as presently perceived.

### BRIEF DESCRIPTION OF DRAWINGS

The present disclosure will be described hereafter with reference to the attached drawings which are given as non-limiting examples only, in which:

FIG. 1 is a flow chart of an example process according to an embodiment of the present invention;

FIG. 2 is an example reference architecture that could be used in the process;

FIGS. 3-5 are examples metrics that could be generated during the evaluations made during the process.

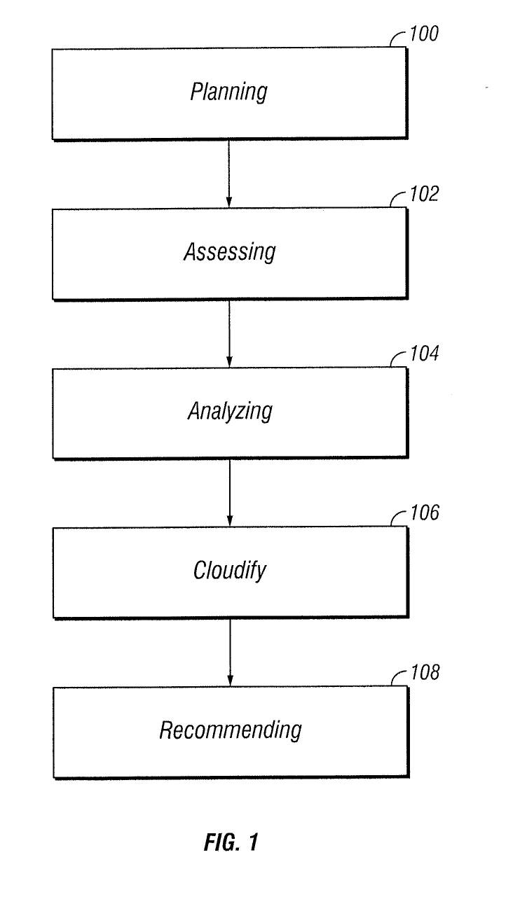

Corresponding reference characters indicate corresponding parts throughout the several views. The exemplification set out herein illustrates embodiments of the invention, and such exemplification is not to be construed as limiting the scope of the invention in any manner.

### DETAILED DESCRIPTION OF THE DRAWINGS

The present disclosure is directed and method and system which can be utilized to evaluate and assess the readiness of enterprise applications for the cloud. This disclosure could be used in a variety of contexts, such as portfolio assessment, topology recommendation, reference architectures, application migration assessment, migration strategy and roadmap, and migration effort estimation.

The process divides the assessment and evaluation process in a series of steps or phases, and each phase will indicate a progression in teems of the assessment process. In one embodiment, the process is divided into a planning stage 100, an assessment stage 102, an analysis stage 104, a cloudify stage 106 and a recommend stage 108.

In the planning stage, there is an assessment of the scope of work, and planning the activities needed to be completed in order to provide the right level of consultancy services. The plan phase documents the scope and schedule of assessing the application/s that needs to be considered for migrating to cloud. Prior to this stage, key stakeholders are identified within the enterprise for discussions and workshops. Time of the stakeholders as well as people who will provide inputs regarding enterprise objectives and applications are also reserved in advance. With this information, the scope of work is identified. For example, a workshop could be held with the application stakeholders. In some cases, this workshop will cover:
An overview of our offerings for cloud
Explanation of our methodology for Cloud Enablement (MACH)
Validating the inventory of application artifacts with the stakeholders
Arrive at the list of applications to be included in the scope.
   For example, there could be a determination of whether the scope is only assessing a single application that needs to be software as a service (“SAAS”) enabled, or is it for moving the entire set of applications to cloud. Another determination that could be made is whether the scope includes an evaluation of feasibility of a private cloud or public cloud for an application, a portfolio, or an enterprise, and other such questions will be asked to define the exact scope of work. With the scope of work defined, a plan is created for the overall assessment exercise. This will involve delineating all the activities that needs to be performed, clearly indicating milestones, dependencies, etc. The plan will also list the people that need to be involved so that the delays are minimized. Additionally, it will contain checkpoints to measure the progress and highlight any issues or risks in the process. The deliverables for this phase are confirmed. For example, a workshop could be conducted after closing the scope and the plan to confirm the list of deliverables that one can expect. This will ensure that the parties involved clearly understand the expectations and the output to avoid ambiguities. At the end of this phase, there should be a signed off plan and the deliverables template from the customer. Some of the key considerations that are pertinent to this phase are:
Consider the end goal of the exercise in terms of expectations of client. Is the goal to have a plan and roadmap for migrating to cloud, or the feasibility of whether a cloud can be considered or not.
In order to define the list of applications to be included in the scope, we will need input from the domain experts from our customers on any business/legal implications of moving the application to cloud.
Identify the people and resources that are needed for the assessment. Identify the SMEs from various areas of expertise (Technology+Domain), delivery manager, domain SMEs, etc. Identify the people who can support evaluators during the definition of objectives and the subsequent analysis of the applications. Document the availability of all the resources at the necessary schedule timelines. In case if any of the resources are not available, document it in the plan as a constraint.
Define the checkpoints for each phase, its duration, the attendees required for the checkpoints and the outcome, if any
Define the stakeholders that provide sign off on the deliverables
Evaluate if a Proof-Of-Concept is needed to validate/benchmark any suggestions or concepts. Add the necessary activities in the plan, as well as the selection of the Proof-Of-Concept application and the measurement criteria

At the end of this stage, typical deliverables include:
Scope
The Consulting scope will list the end objective behind the consulting exercise, including the applications that need to be assessed for migrating to cloud and the type of recommendations that is expected to be provided.
Plan
The consulting plan contains the timelines, the milestones and the activities involved with the required resources for each of the activities identified for each of the in scope consultations
Report template
The template of the deliverable at the end of the assessment exercise will be included.

The next stage, assessment, aims at understanding the organization's landscape and requirements for cloud and defining the goals and objectives for adopting cloud. The process for assessment involves looking at the application landscape from a technical stack, as well as looking at the business domain model and its functionality requirements. Application usage, statistics and trends are also assessed. Finally, in some embodiments, all of these are consolidated into a set of objectives for adopting cloud. Both business and technical objectives are to be documented based on the meetings with the stakeholders. These objectives discovered and documented at this point of the assessment serves as a guiding force for the next phases. In the assessment process, the following is a non-exhaustive list of typical activities:
Understand high level business and technical drivers for moving to cloud
   The idea here is to understand the business drivers for adopting cloud. This involves finding out current issues, looking at the agility and efficiency requirements that are desired for the business. The current enterprise goals for that particular line of business will also feed in to shape the cloud adoption objectives.
Evaluate the existing enterprise landscape and strategy and future needs
   In order to recommend the right cloud solution that would have minimum disruptions, one also needs to assess the existing enterprise landscape, from a technical architecture, as well as from an infrastructure and systems point of view. Overall strategy of the portfolio, or its future needs also provide insights into how the applications within the portfolio are going to evolve.
Understand the current application usage context and trends
   The current application usage, its current issues, resolutions and workarounds, all feed in to define the right cloud objectives that will aide in resolving the important issues. For example, an application having a high number of downtime can be assessed to include a higher availability objective for a cloud, apart from the usual cost and performance objectives.
Define objectives for moving to cloud
   All the data above are analyzed in totality to arrive at a set of objectives for cloud adoption. These objectives should clearly indicate why does the enterprise want to move to cloud. These objectives also help determine Key Success Criteria in future phases, that will help in measuring the objectives and consequently, the effectiveness of the cloud.

The above activities are typically done with the help of an exhaustive questionnaire along business, architecture and Infrastructure areas that aims to document various features, aspects and tenets of application functionality and its technicalities. These answers are then consolidated and deliberated upon to list down a laundry list of objectives. Each of these objectives are then discussed with the stakeholders and filtered and finalized to arrive at the final cloud objectives. Some of the key considerations during this phase are:
Try to get as realistic and as accurate an answer to the questionnaire as possible
Avoid using adjectives in the answers to the questionnaire such as very high, huge, etc. Use quantifiable numbers, such as 3 out of 10 applications are on the java stack with Webshpere 3.1 as the application server.
While defining the objectives, first identify the key objectives from each business, Information Systems and Technical Infrastructure areas and then try to battle them across each other to see how they fare.
Though objectives will be for a majority of your application space and their requirements, do look at the minority and consult with the customer if they are open to having a separate objective/solution for the remainder or a minority set of applications. In that case, try to analyse the minority and create a new set of objectives in a similar manner.
   At the end of this assessment stage, the following is a non-exhaustive list of typical deliverables:
Domain Assessment Questionnaire
This document contains the exhaustive set of questions around the portfolio such as the market agility, the information distribution and its related security, the organizations future roadmap, its application life cycle, etc.
Technical Assessment Questionnaire
This document contains the exhaustive set of questions around the technical landscape of the organization such as infrastructure and the platform distribution, access controls, cross cutting technical functions, configuration management, etc.
Objectives Document
This document contains list of objectives which in turn will provide the drivers for cloud adoption. Each objective will be listed with a reasoning on why the objective is necessary for the organization.

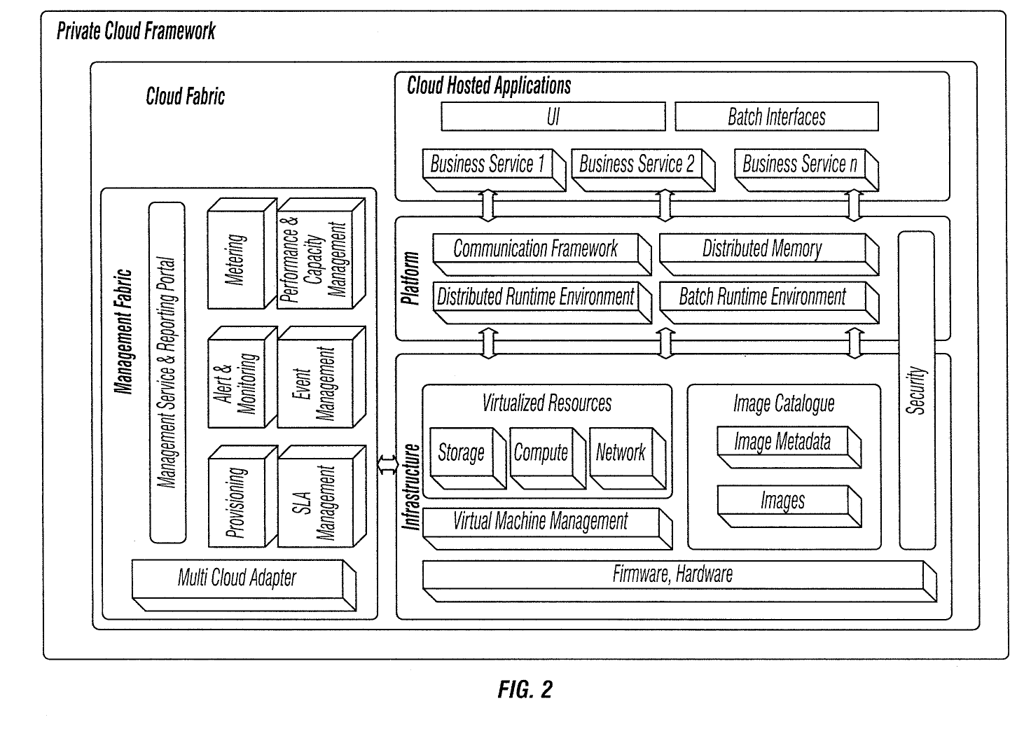

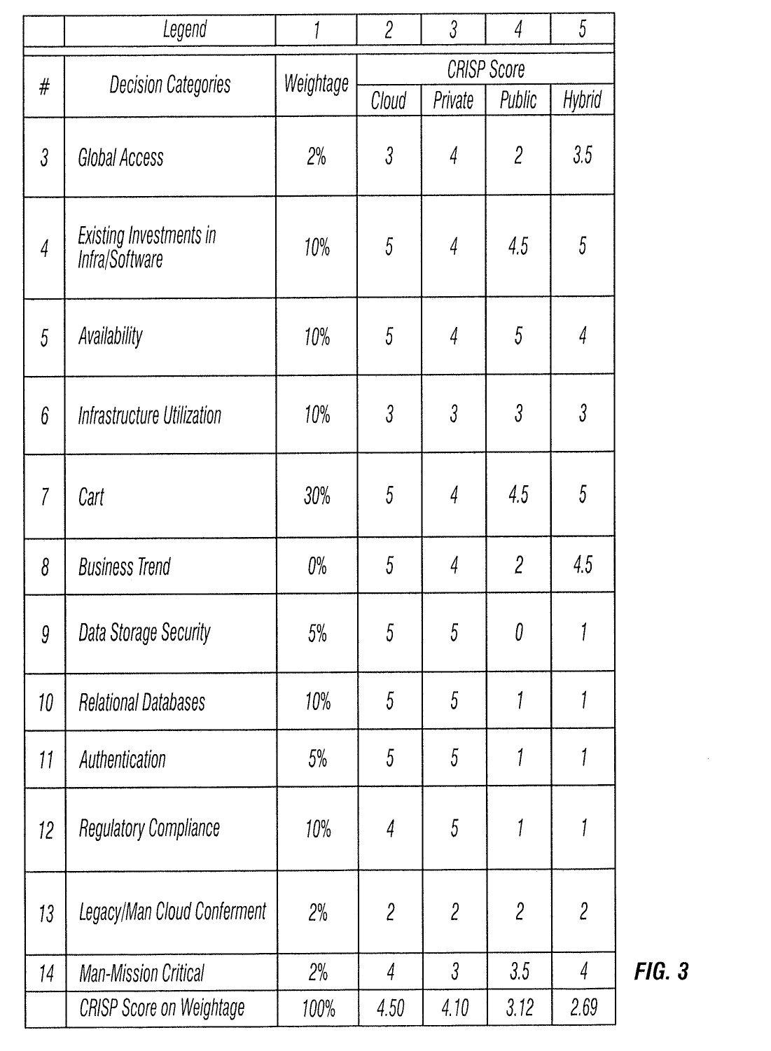

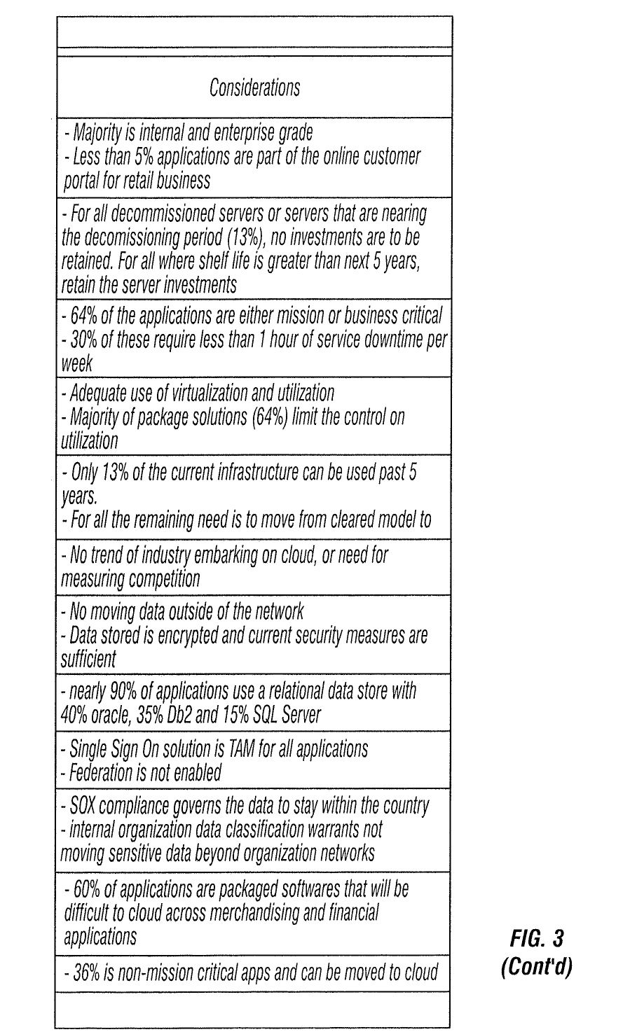

Once the assessment stage has been completed, the next stage is the analysis phase. This stage will include the activities to evaluate the answers to the questionnaire and apply the cross industry standard process (“CRISP”) framework to arrive at a quantifiable score for defining the public, private and hybrid propensity of the applications for the organizations. The best score among them can then be selected. Subsequently, one or more cloud architectures are prepared to lay down the blueprint of the organizations cloud and the decided cloud vendors products identified for the architecture. For these cloud architecture(s), an application reference architecture is also created to model how applications will eventually look and work on the target cloud platform. FIG. 2 is an example of application reference architecture. All current applications can then be updated to this reference architecture for an efficient and a factory oriented migration. This phase can optionally include any Proof of Concepts that are needed or desired to benchmark or prove any concept, design or method as well as evaluate the benefits of a particular cloud architecture or component. The following is a non-exhaustive list of activities that could be performed in this stage:
Apply guidelines to arrive at CRISP score for Cloud Topology (Public/Private)
This involves analysing the responses in the questionnaire along a set of predefined categories in the CRISP scoring sheet, providing a score based on the guidelines provided for the CRISP scoring sheet, and then assigning weightages to the CRISP categories based on the objectives defined during the previous phase of the process. One has to provide a score for the public, private and hybrid column.
Evaluate responses to get CRISP Score for Cloud Implementation Type (PAAS)
This involves analysing the responses in the questionnaire along a set of predefined categories in the CRISP-PaaS scoring sheet, providing a score based on the guidelines provided for the CRISP-PaaS scoring sheet, and then assigning weighages to the CRISP-PaaS categories based on the objectives defined during the previous phase of the process.
Define the right cloud platform and architecture
This involves creating a blue print of the cloud platform from a Reference Cloud Architecture, such as the example architecture shown in FIG. 3. One has to analyse whether each of the components is required, and detail the functionality of the component, including the degree of automation and benefits.
Prepare reference architecture for applications to be migrated to cloud
Based on the components defined in the cloud platform, develop a reference application architecture that can work efficiently on the cloud. Do include the integration points and the communication interfaces that need to be used between the cloud platform and the cloud applications.
POC and benchmarking (Optional)
In scenarios where POC is in scope one might have to build a test cloud, deploy an architecturally significant module from the application/s in scope, in the cloud test environment and carry out functional and non-functional tests on the deployment in a simulated peak usage scenario. The results from the non-functional tests have to be documented and used as benchmarks for all other modules when they get deployed. This activity also serves a pre-validation on the cloud initiative by comparing the metrics obtained during the POC to the quantified objectives expected from the cloud adoption.

The following is a non-exhaustive list of considerations that could be made during this phase:
While providing score for CRISP, analyze the objectives and the categories objectively and not subjectively. For example, when analyzing if investments in software are to be re-used or not, do not consider security of applications to give a score.
When assigning weightages to each CRISP category, work with the customer to understand the priority of each category first and then the importance of the category.
Giving a zero weightage to categories that are not applicable to the customer will ensure that the score will reflect a much clearer suggestion. However, do check that the total of all weightages adds up to 100% in the CRISP sheet.
In the cloud platform architecture, cover the processes of provisioning, scaling up and down, security as well as availability.
When defining the monitoring and management framework, do try to factor in the alerting mechanism that is needed by the customer, with also SLA management, if required.
Depending on the returns required, try to automate as many processes as possible, as that would improve the effectiveness of the cloud
For POC, clearly define the objective and document it. It should generally be in to either validate a new concept, or benchmark an already proven platform. For example, in case you want to introduce self-healing via a script that triggers when a threshold is reached, the objective should be clearly defined as to test the script to trigger on threshold values.
Usage of management tools to collect the metrics during a POC is not mandatory and custom methods could be used to do it as setting up of management tools would take up some time and effort which may not be required in POC stage.

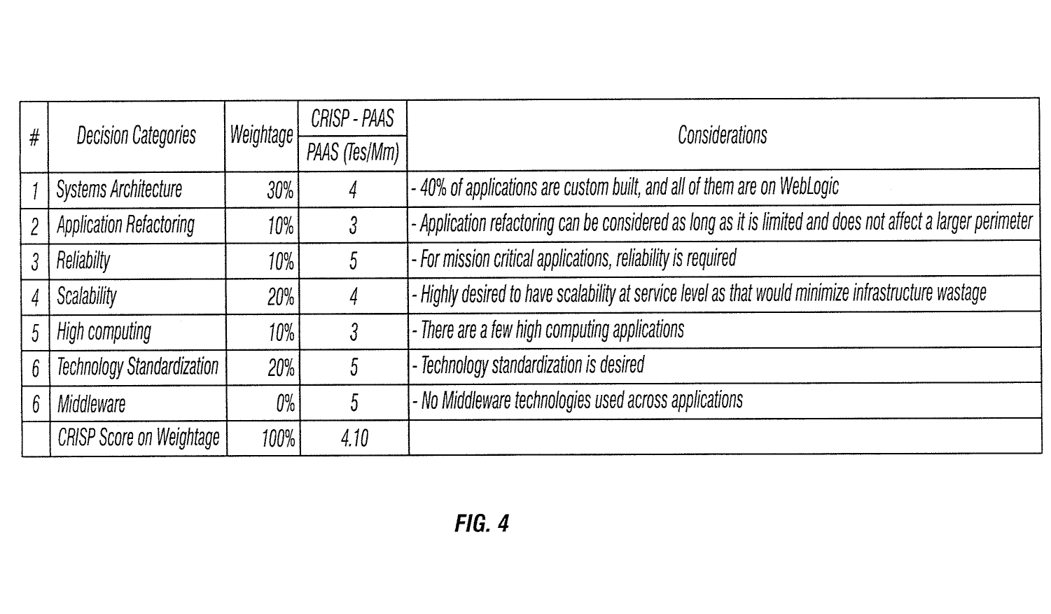

The following is a non-exhaustive list of deliverables from this stage:
CRISP Score
Depending on the circumstances, this could be a comparative score taken across 15 categories for Public Cloud, Private Cloud and Hybrid Cloud. FIG. 4 is an example score for an example scenario. For each of these cloud topologies, scoring will be provided for each of the categories and the scores would then be summed up based on the relative weightages for each of the categories. The final score would indicate whether it is feasible and recommended to adopt a specific cloud topology for the applications or portfolio in scope.
CRISP Score for PAAS
Depending on the circumstances, this could be a comparative score taken across 7 categories for Platform As A Service, such as shown in FIG. 4. Scoring will be provided for each of the categories and the scores would then be summed up based on the relative weightages for each of the categories. The final score would indicate whether it is feasible and recommended to adopt Platform As A Service type of cloud for the applications in scope.
Cloud Architecture
This is the cloud architecture document that provides the blue-print of the cloud, its various components, as well as how they interact with each other and the applications that are hosted in cloud.
Application Reference Architecture
This would provide a reference architecture that each of the applications to be hosted on cloud should migrate to for optimum benefits realization in the cloud. There could be more than one reference architecture depending on the technologies, the cloud, and current architectural styles being employed. Each has to be documented here.
POC and Benchmarking Report (Optional)

This report will provide the objective, the details and the result of the POC done during the process to validate concepts or review benchmarks.

The next stage, cloudify, marks the transition of the evaluation from the cloud platform as a whole to the applications to be hosted on cloud. Here, we understand each of the applications in order to determine how to best migrate them, define the migration strategy, and also how to measure the effectiveness of the application on the cloud platform. In some embodiments, the cloudify phase will include the following non-exhaustive list of activities:
Define categories for Application Fitment Score depending on the reference architecture
Based on the objectives defined for the cloud, the Cloud platform architecture and the application reference architecture, define the categories that will need to be used for assessing the application migration feasibility for the cloud. Start with the pre-defined exhaustive categories, and review what is needed and what is not. For each that is needed, provide a weightage to determine the categories importance with respect to other categories. In case the objectives or the reference architectures warrant another category, add a new category with its relative weightage.
Feasibility analysis of moving applications to cloud (fitment score)
Once the categories have been defined, assess all the applications in scope along each of the categories for providing a score.
Define rules for Cloud Code Analysis Tool (CCAT)
Go through each of the cloud objectives, and define Rules that one would want to check for in applications by a code evaluation tool, such as the one described in U.S. Ser. No. 13/746,554, filed Jan. 22, 2013, which is hereby incorporated by reference. Each objective would potentially have multiple rules that check through the breadth of the application for any non-conformities or problems.
Execute Cloud Code Analysis Tool on applications
Finally, execute CCAT on each application code to arrive at the number of non-conformities within each application. This number along with the complexity of the rule and the time required to resolve will provide with a good effort estimation through CCAT.
Identify and Confine Key Success Criteria (KSC) based on objectives
For each of the objectives identified and the application reference architectures defined, identify Key Success Criterias for your applications. These KSCs are more quantifiable with respect to the applications as compared to the objectives. For example, if the objective was to improve the utilization by 20%, the KSCs could be that for each of the physical servers, check if the CPU utilization is 55% and memory utilization is now 70% of the total CPU and memory allocated respectively. These KSCs help in the eventual migration where one will only need to compare the metrics to see if the expected realization has happened, or further investigation is required.
The following is a non-exhaustive list of considerations for this stage:
   A workshop with the stakeholders might be needed again here to confirm the weightages provided to each of the AFS categories.
   A rare possibility is of different application owners considering different priorities as important. Explain that as we need to compare the applications, we will need to relatively score them. This might require discussing with both and arriving at the right weightage for each of the disputed categories.
   If available, document KSCs in quantifiable terms. For example, SLA requirements, performance requirements and so on.
   Liaise with the Cloud Vendor Selection team to understand how the objectives and KSCs are taken care of by the cloud vendor in consideration.
   Identify KSCs that need to be specifically handled by the application architecture.
   Confirm the timelines for implementation of the migration to cloud. This should be included in the KSCs explicitly to enable a more precise roadmap for migrating applications to cloud.

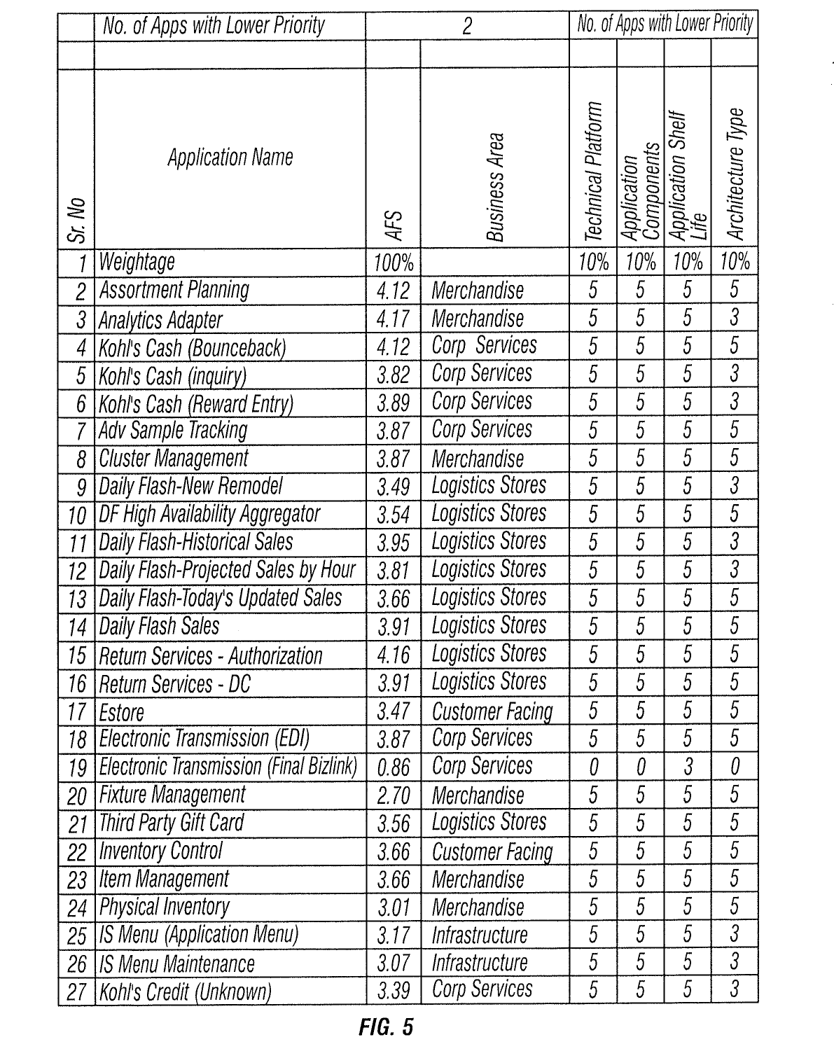

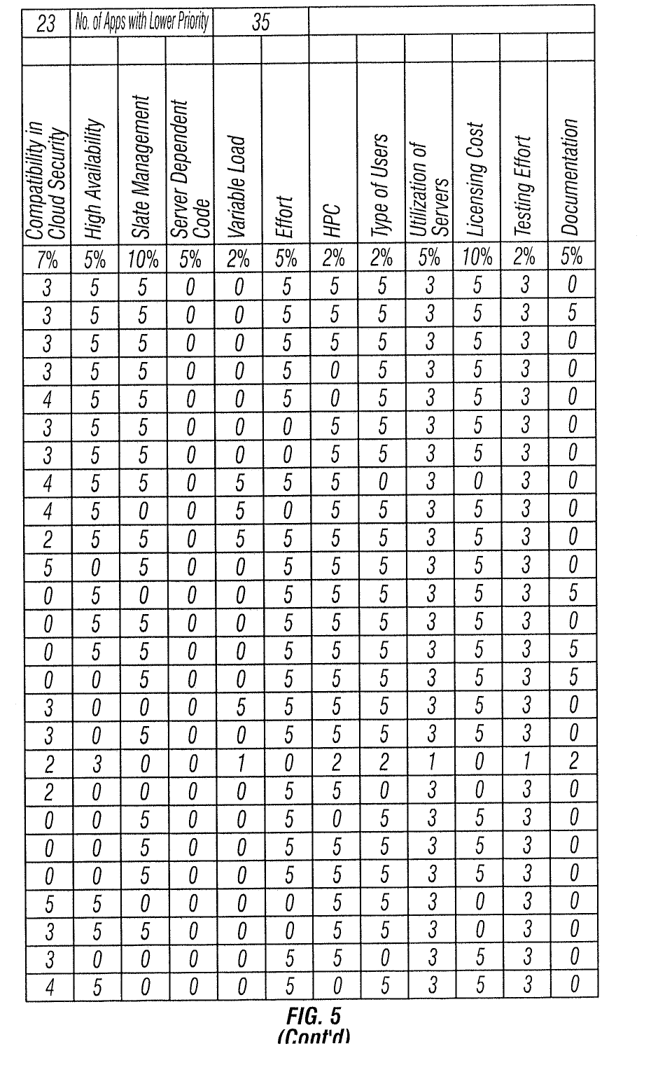

The following is a non-exhaustive list of deliverables for this stage:
Updated Reference Architecture Document with KSCs
This document specifies the KSCs applicable for each application reference architecture. Each KSCs are mapped to an objective that is defined in the objective document.
CCAT Execution Report
This document contains all CCAT rules identified and defined to be executed on the applications will be listed here. Each rule will indicate the function it performs, the criticality (blocking, critical, medium and low) as well as any remediation mechanisms if possible. Each of these rules, when run through each of the applications in scope, and the respective output will be listed here. Apart from individual reports, one can also get a summary report across applications.
Application Fitment Score
This document contains the final Application Fitment categories and their weightage relative to each other. Each of the application in scope has a score assigned, such as between 1 to 5, across each category. An example fitment score for a scenario is shown in FIG. 5. Finally, each application has a consolidated score calculated based on the score assigned and the weightage assigned. Applications are also marked based on their priority to indicate easy or difficult migration.

The recommendation stage is the culmination of the entire consulting exercise. It will provide the customer with the necessary insights on its enterprise application landscape and its readiness to move to cloud. Depending on the circumstances, the recommend phase may include the following non-exhaustive list of activities:
Present the findings and the selected cloud strategy for the enterprise
Using CRISP, CRISP for PaaS and the assessment questionnaire, we try to recommend the cloud adoption strategy and topology that the enterprise can use for its cloud journey
Define cloud specific architectural standards and configuration parameters for the selected cloud implementation
Using Cloud platform architecture and the application reference architectures, we recommend the standards and configuration parameters that need to be defined and configured for an effective cloud.
Present the roadmap for moving applications to cloud
Using the Application Fitment Score and the CCAT report, provide a roadmap of how and when each application has to be migrated to the cloud. Also indicate whether a Greenfield approach makes sense or not. If it is a gradual approach, explain how migrated applications would interact with the other applications which are currently on-premise but would eventually be cloud enabled
Provide Effort Estimate to move to cloud
Using the CCAT report, provide application migration estimates for migration to cloud.

The following is a non-exhaustive list of deliverables for the recommendation stage:
Adoption Report
The Adoption Report will summarize our approach, key findings and our recommendations as defined and confirmed in the Plan phase.
Estimates
   This will include effort and Cost estimates for migrating to the defined cloud platform using Syntel's proven Software Factory model

Although the present disclosure has been described with reference to particular means, materials and embodiments, from the foregoing description, one skilled in the art can easily ascertain the essential characteristics of the present disclosure and various changes and modifications may be made to adapt the various uses and characteristics without departing from the spirit and scope of the present invention as set forth in the following claims.

What is claimed is:

1. A method of evaluating readiness of applications for the cloud, the method comprising the steps of:
planning a scope of work by assessing which software applications are under consideration for migration to the cloud;
assessing the software applications under consideration for migration to the cloud to determine technical objectives;
analyzing the software applications under consideration for migration to the cloud to determine a score representative to propensity of respective applications to a public, private or hybrid cloud architecture;
defining a migration strategy based on the assessing and analyzing steps;
recommending a readiness of the applications under consideration for migration to the cloud.

2. The method as recited in claim 1, wherein the assessing step includes an assessment of an existing enterprise landscape from a technical architecture.

3. The method as recited in claim 1, wherein the assessing step includes an evaluation of usage of the software applications under consideration for migration to the cloud.

4. The method as recited in claim 1, wherein the assessment step includes storing answers to a questionnaire concerning one or more of architecture and infrastructure features of the software applications under consideration for migration to the cloud.

5. The method as recited in claim 4, wherein the questionnaire requires answers that are one or more numbers.

6. The method as recited in claim 4, wherein the questionnaire includes a domain assessment questionnaire.

7. The method as recited in claim 6, wherein the questionnaire includes a technical assessment questionnaire.

8. The method as recited in claim 1, wherein the analyzing step includes an evaluation of the software applications under consideration for migration to the cloud using a CRISP framework.

9. The method as recited in claim 1, wherein the analyzing step includes an evaluation based on an application reference architecture.

10. The method as recited in claim 1, wherein the analyzing step includes a proof of concept build.

11. The method as recited in claim 10, wherein the proof of concept simulates a peak usage scenario.

12. The method as recited in claim 10, wherein the proof of concept performs functional and non-functional tests on a test environment.

13. The method as recited in claim 1, wherein the defining step defines categories for an application fitment score.

14. The method as recited in claim 13, wherein the defining step includes weighting at least a portion of the categories.

15. The method as recited in claim 14, wherein the defining step includes a feasibility analysis of moving the software applications under consideration for migration to the cloud.

16. The method as recited in claim 15, wherein the defining step includes defining rules for use by a code evaluation tool on the software applications under consideration for migration to the cloud.

17. The method as recited in claim 16, wherein the defining step includes an analysis of application code for moving the software applications under consideration for migration to the cloud to determine a number of non-conformities within each application.

18. The method as recited in claim 1, wherein the recommending step includes defining a specific architecture for the software applications under consideration for migration to the cloud.

19. The method as recited in claim 18, wherein the recommending step includes defining one or more configuration parameters for software applications under consideration for migration to the cloud.

20. The method as recited in claim 19, wherein the recommending step includes providing an effort estimate for moving the software applications under consideration for migration to the cloud.
